(19) United States
(12) Patent Application Publication
(10) Pub. No.: US 2014/0063360 A1
(43) Pub. Date: Mar. 6, 2014

(54) INPUT DEVICE

(71) Applicants: Yousuke Kunishi, Gyouda-shi (JP); Hideki Suzuki, Tokyo (JP); Hiroto Komatsu, Saitama-shi (JP); Junichi Ikeno, Saitama-shi (JP)

(72) Inventors: Yousuke Kunishi, Gyouda-shi (JP); Hideki Suzuki, Tokyo (JP); Hiroto Komatsu, Saitama-shi (JP); Junichi Ikeno, Saitama-shi (JP)

(21) Appl. No.: 13/704,343

(22) PCT Filed: Jun. 17, 2010
(86) PCT No.: PCT/JP2010/004058

§ 371 Date: Dec. 27, 2012

(51) Int. Cl. G02F 1/1333

(52) U.S. Cl. CPC G02F 1/13338
USPC 349/12

(57) ABSTRACT

An input device includes an input member in which a pair of conductive substrates including an insulating substrate and a transparent conductive film that is provided on the insulating substrate and has a mesh-shaped member made of a conductive metal in an insulating transparent body are provided so as to be laminated in a thickness direction, and a detection means for being electrically connected to the transparent conductive film, and detecting an input signal. Here, a conductive portion in which the mesh-shaped member is arranged in the transparent substrate and an insulating portion in which at least one part of the mesh-shaped member in the transparent substrate is removed are provided on the transparent conductive film.

### TECHNICAL FIELD

The present invention relates to an input device that is provided on a front surface of an image display device for electromagnetic wave shield of a touch panel and a plasma display.

### BACKGROUND ART

In a touch panel, an input device is provided on the front surface of an image display device such as a liquid crystal display or the like, and has a conductive substrate, as an electrode sheet, in which a transparent conductive layer (a transparent conductive film) is formed on a surface of a transparent insulating substrate.

As a material constituting a transparent conductive layer of the conductive substrate of the input device, a π-conjugated conductive polymer (an organic conductor) represented by tin-doped indium oxide (ITO) or polyethylene dioxythiophene-polystyrene sulfonic acid has been widely known.

However, in the conductive substrate used in the input device for a touch panel, a circuit pattern or an antenna array pattern may be formed.

As a method of forming a pattern, for example, in Patent Document 1, a method in which a transparent conductive layer is formed on the entire surface of a transparent body by coating to thereby be irradiated with a YAG laser beam having a pulse width of about 100 nanoseconds using a CO₂ layer or Q-switch, and then a transparent conductive layer of a part that is insulated is removed by ablation is disclosed.

In Patent Documents 1 and 2, a method in which a conductive portion is formed on a surface of a transparent substrate in a predetermined pattern by a printing method such as a screen printing method or a gravure printing method is disclosed.

In Patent Document 4, a method in which a transparent conductive layer is formed on the entire surface of a transparent substrate by coating, and then a transparent conductive layer of a portion that is insulated is removed by plasma etching is disclosed.

In Patent Document 5, a technique in which a transparent conductive film obtained by dispersing and curing metallic nanowires (extremely fine metallic fibers) in a binder (resin) is irradiated with a laser beam so as to be insulated to thereby form a conductive pattern is disclosed The metallic nanowire which protrudes from the transparent conductive film is removed by irradiating with a laser beam.

In Patent Document 6, a technique is disclosed in which the beam diameter and focal length of a lens are controlled using an ultraviolet laser beam with respect to an ITO deposition substrate for a touch panel, and the processing width is controlled in a condensing area, and therefore a fine pattern is formed by fine ablation of about 10 μm.

### CITATION LIST

### Patent Documents

[Patent Document 1] Japanese Unexamined Patent Application, First Publication No. 2004-118381

[Patent Document 2] Japanese Unexamined Patent Application, First Publication No. 2005-527048

[Patent Document 3] Japanese Unexamined Patent Application, First Publication No. 2008-300063

[Patent Document 4] Japanese Unexamined Patent Application, First Publication No. 2009-26639

[Patent Document 5] Japanese Unexamined Patent Application, First Publication No. 2010-44968

[Patent Document 6] Japanese Unexamined Patent Application, First Publication No. 2008-91116

### SUMMARY OF INVENTION

### Technical Problem

In general, the above-described organic conductor is blue to green in color and ITO is pale yellow in color.

Therefore, when forming a conductive pattern on an insulating substrate using the methods of Patent Documents 1 to 4, a conductive portion takes on a color peculiar to the conductor forming each conductive film, and an insulating portion of the insulating substrate only becomes colorless. Accordingly, in a case in which the obtained conductive substrate used as an input device is provided on a front surface of an image display device, a conductive pattern would be visible if the width (a width perpendicular to an extending direction of the insulating portion) of the insulating portion is not minimized. On the other hand, if the width of the insulating portion is minimized, there is a possibility that the insulating property is not secured.

Patent Document 5 has the advantage that the conductive pattern of the input device is hardly visible. However, inside a transparent conductive film, metallic nanowires remain in the insulating portion as well as the conductive portion, and therefore it is difficult to ensure insulation. That is, in order to reliably insulate the insulating portion, it is necessary to control the thickness of the transparent conductive film.

In addition, in Patent Document 6, it is necessary to use an ultraviolet laser beam using high-order harmonic waves in the processing, and it is difficult to cope for a commercially available laser processing machine to adjust the diameter of a laser beam or the focal length of a zoom lens in order to control the width of an ablation area.

The present disclosure has been made in an effort to provide an input device in which a conductive pattern is hardly visible even though the width of an insulating portion is formed to be larger, and a stable electrical performance is obtained by reliably insulating the insulating portion.

### Solution to Problem

According to an embodiment of the present disclosure, there is provided an input device including: an input member in which a pair of conductive substrates including an insulating substrate and a transparent conductive film that is provided on the insulating substrate and has a mesh-shaped member made of a conductive metal in an insulating transparent body are provided so as to be laminated in a thickness direction; and detection means for being electrically connected to the transparent conductive film, and detecting an input signal, wherein the transparent conductive film includes a conductive portion in which the mesh-shaped member is arranged in the transparent substrate and an insulating portion in which at least one part of the mesh-shaped member in the transparent substrate is removed.

In addition, in the input device according to an embodiment of the present invention, a void formed by removing the mesh-shaped member may be arranged in the insulating portion.

In addition, in the input device according to an embodiment of the present invention, the mesh-shaped member may be formed of extremely fine metallic fibers that are dispersed in the transparent substrate and electrically connected with each other.

In addition, in the input device according to an embodiment of the present invention, the extremely fine metallic fibers may contain silver as a main component.

In addition, in the input device according to an embodiment of the present invention, the void of the insulating portion may be formed in such a manner that the mesh-shaped member is irradiated with a pulsed laser beam.

In addition, in the input device according to an embodiment of the present invention, the pulsed laser beam may be an extremely short pulse laser beam having a pulse width shorter than 1 picosecond.

In addition, in the input device according to an embodiment of the present invention, the pulsed laser beam may be a YAG laser beam or a YVO₄ laser beam.

In addition, in the input device according to an embodiment of the present invention, the insulating substrate may be transparent.

In addition, in the input device according to an embodiment of the present invention, in the input member, the transparent conductive films of the pair of conductive substrates may be respectively arranged toward the same side along the thickness direction of the conductive substrates, and the detection means may be a capacitive detection means.

In addition, in the input device according to an embodiment of the present invention, in the input member, the transparent conductive films of the pair of conductive substrates may be disposed in close proximity with each other so as to oppose each other with a space provided therebetween, and parts of the transparent conductive film may be electrically brought into contact with each other by an input operation.

### Advantageous Effects of Invention

According to an input device according to an embodiment of the present invention, a conductive pattern may be hardly visible even though the width of an insulating portion is formed to be larger, and stable electrical performance may be obtained by reliably insulating the insulating portion.

### BRIEF DESCRIPTION OF DRAWINGS

FIG. 1 is a side cross-sectional view showing a simplified input member of an input device according to a first embodiment of the present invention;

FIG. 2 is an enlarged photograph showing a mesh-shaped member (a conductive portion) of a transparent conductive film of an input member and a transparent conductive film before laser processing, which are used in an input device according to the first embodiment of the present invention;

FIG. 3 is an enlarged photograph showing a void (an insulating portion) formed by removing a mesh-shaped member in a transparent conductive film of an input member used in an input device according to the first embodiment of the present invention;

FIG. 4 is a side view showing a simplified manufacturing device (a laser processing machine) for manufacturing a transparent conductive film and a conductive substrate of an input member of an input device according to the first embodiment of the present invention;

FIG. 5 is a side view showing a modification example of the conductive substrate and the manufacturing device of FIG. 4;

FIG. 6 is an enlarged photograph showing a conductive portion of a transparent conductive film and a transparent conductive film before a laser beam processing according to a comparative example;

FIG. 7 is an enlarged photograph showing an irradiation region (an insulating portion) of a transparent conductive film according to a comparative example;

FIG. 8 is a side view showing an example (a manufacturing example) of manufacturing an input member (a transparent conductive film and a conductive substrate) of an input device according to an embodiment of the present invention;

FIG. 9 is a side view showing an example (a manufacturing example) of manufacturing an input member (a transparent conductive film and a conductive substrate) of an input device according to an embodiment of the present invention;

FIG. 10 is a perspective view showing an example (a manufacturing example) of manufacturing an input member (a transparent conductive film and a conductive substrate) of an input device according to an embodiment of the present invention;

FIG. 11 is a circuit diagram showing an example (a manufacturing example) of manufacturing an input device according to an embodiment of the present invention;

FIG. 12 is a top view showing an input member of an input device according to a second embodiment of the present invention;

FIG. 13 is a top view showing an X side electrode sheet (a conductive substrate) of the input member of FIG. 12;

FIG. 14 is a top view showing a Y side electrode sheet (a conductive substrate) of the input member of FIG. 12;

FIG. 15 is an enlarged side cross-sectional view taken along an A-A line of FIG. 12; and

FIG. 16 is an enlarged side cross-sectional view taken along a B-B line of FIG. 12.

### DESCRIPTION OF EMBODIMENTS

### First embodiment

An input device according to an embodiment of the present invention may be applied to a product in which a wiring pattern is formed in a transparent portion, in the same manner as a transparent input device such as a transparent antenna, a transparent electromagnetic wave shield, a capacitance-type or a membrane-type transparent touch panel, or the like. In addition, the input device according to an embodiment of the present invention may be used for the purpose of forming an electrode required for a capacitance sensor that is provided on the surface of a three-dimensional (3D) molded article or a 3D decorative molded article, such as a capacitance input device attached to a steering wheel or the like of an automobile. In addition, “transparent” throughout the present embodiment refers to having a light transmittance of 50% or more.

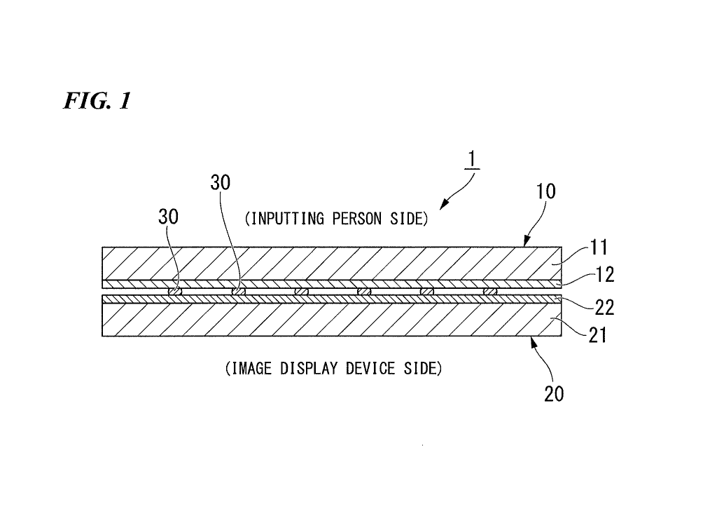

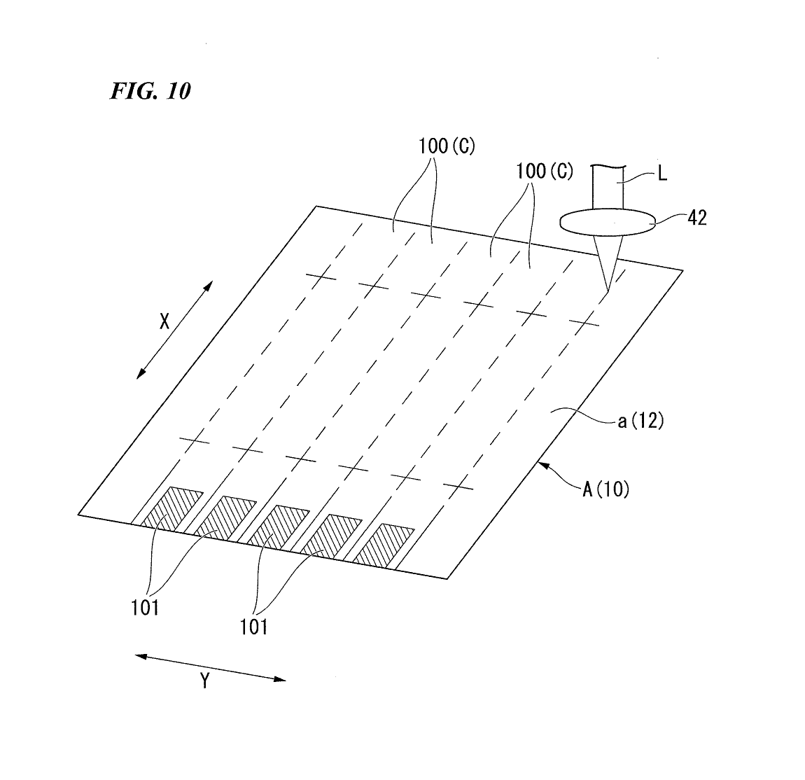

FIGS. 1 and 10 show an input member 1 for a membrane-type touch panel (an input device) according to a first embodiment of the present invention. In FIGS. 1 to 3, the membrane-type touch panel includes an input member 1 in which a pair of conductive substrates 10 and 20 including insulating substrates 11 and 21 and transparent conductive films 12 and 22 that are provided on the insulating substrates 11 and 21 and have a mesh-shaped member 3 made of a conductive metal in an insulating transparent body 2 are provided so as to be laminated in a thickness direction, and a detection means that is electrically connected to the transparent conductive films 12 and 22, and detects an input signal.

The input member 1 is arranged on a side of an inputting person of an image display device (not shown) such as LCD or the like. In FIG. 10, the input member 1 includes the conductive substrate 10 in which electrodes 100 (corresponding to a conductive portion C of the transparent conductive film 12 which will be described below) along a row (X) direction are arranged in parallel, the conductive substrate 20 that is disposed on the image display device side so as to face the conductive substrate 10 and in which electrodes (corresponding to the conductive portion C of the transparent conductive film 22) along a column (Y) direction perpendicular to the row (X) direction are arranged in parallel, and a transparent dot spacer 30 that is provided between the conductive substrates 10 and 20. The input member 1 has a configuration in which the electrode 100 of the conductive substrate 10 and the electrode of the conductive substrate 20 are contacted and conducted with each other in a DC manner by an input operation.

The conductive substrate 10 includes a transparent insulating substrate 11 and a transparent conductive film 12 that is provided on a surface facing at least the image display device side on the insulating substrate 11.

The conductive substrate 20 includes a transparent insulating substrate 21 and a transparent conductive film 22 that is provided on a surface facing at least a side of an inputting person on the insulating substrate 21.

As the insulating substrates 11 and 21, an insulating substrate which may form the transparent conductive films 12 and 22 thereon while having an insulating property, and be less liable to a change in appearance in predetermined irradiation conditions with respect to laser processing which will be described below may be preferably used. Specifically, as an example of a material of the insulating substrates 11 and 21, an insulating material such as glass, polycarbonate, polyester representing polyethylene terephthalate (PET), and the like, acrylonitrile-butadiene-styrene copolymer resin (ABS resin), or the like may be given. In addition, as the insulating substrates 11 and 21, a plate-shaped insulating substrate, a flexible film-like insulating substrate, and a molded article that is molded three-dimensionally (3D), or the like may be used.

When using the above-described input member 1 in the transparent touch panel, a glass plate, a PET film, or the like may be used as the insulating substrates 11 and 21. In addition, when the input member 1 is used as an electrode required for a capacitance sensor or the like, such as a capacitance input device attached to a steering wheel or the like of an automobile, as the insulating substrates 11 and 21, a molded article made of ABS resin or the like or a decorative molded article in which a decorative layer is provided on the molded article by laminate of a film, transfer, or the like may be used.

For example, when the present invention is used as a transparent touch panel such as a membrane type in which two upper and lower electrode films 12 and 22 (transparent conductive films) are contacted and conducted with each other by pressing force or the like, it is preferable that an insulating substrate (for example, a transparent resin film) that is easily flexible with respect to an external force from the side of the inputting person be used as the insulating substrate 11 of the side of the inputting person, and an insulating substrate having a predetermined hardness (for example, equal to or larger than that of the insulating substrate 11) which is easy to support the conductive substrate 10 through the dot spacer 30 be used as the insulating substrate 21 of the image display device side. In addition, it is necessary to use such a touch panel by providing a predetermined potential difference between the adjacent electrodes 100, and in the transparent conductive films 12 and 22 using a metal such as copper, zinc, or tin, particularly silver, a width (a width perpendicular to the extending direction of the insulating portion) of the insulating portion separating a conductive pattern is required to be ensured in order to prevent migration.

In addition, the transparent conductive films 12 and 22 of the pair of conductive substrates 10 and 20 are disposed in close proximity with each other so as to oppose each other with a space provided therebetween by the dot spacer 20. When the conductive substrate 10 is pressed toward the image display device side from the side of the inputting person, the insulating substrate 11 and the transparent conductive film 12 of the conductive substrate 10 are bent, and the transparent conductive film 12 is brought into contact with the transparent conductive film 22 of the conductive substrate 20. By this contact, electrical signals are generated. That is, in the input member 1, parts of the transparent conductive films 12 and 22 are brought into contact with each other in a DC manner by an input operation of the inputting person.

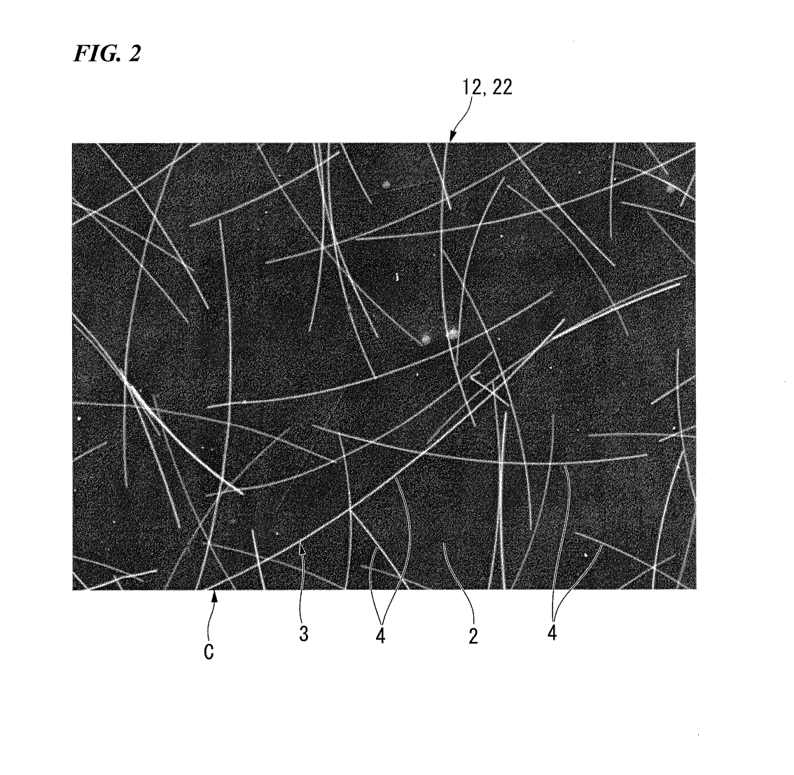

In addition, as shown in FIG. 2, the transparent conductive films 12 and 22 include the mesh-shaped member 3 made of a metal having conductivity in the insulating transparent body 2. The transparent substrate 2 is made of a curable resin that is filled (impregnated) between element wires (fibers) of the mesh-shaped member 3, which will be described below, in a liquid state, and is cured by, for example, heat, ultraviolet rays, electron rays, radiation, or the like.

In addition, the mesh-shaped member 3 is made of a plurality of extremely fine metallic fibers 4 which are dispersed in the transparent substrate 2 and electrically connected with each other. Specifically, the extremely fine metallic fibers 4 are irregularly extended in mutually different directions along the surface direction of a surface (a surface in which the transparent conductive films 12 and 22 are formed) of the insulating substrates 11 and 21, densely arranged to a degree where at least one part or more of the extremely fine metallic fibers 4 are overlapped each other (contacted with each other), and electrically coupled (connected) with each other by this arrangement.

That is, the mesh-shaped member 3 constitutes a conductive two-dimensional (2D) network on a surface of the insulating substrates 11 and 21, and a region in which the mesh-shaped member 3 is arranged in the transparent substrate 2 of the transparent conductive films 12 and 22 is a conductive portion C. In addition, the extremely fine metallic fiber 4 of the mesh-shaped member 3 has a portion embedded in the transparent substrate 2 and a portion protruding from a surface of the transparent substrate 2.

Specifically, as the extremely fine metallic fibers 4, metallic nanowires or metallic nanotubes made of copper, platinum, gold, silver, nickel, or the like may be used. In the present embodiment, as the extremely fine metallic fiber 4, metallic nanowires (silver nanowires) containing silver as a main component are used. The diameter of the extremely fine metallic fiber 4 is about 0.3 nm to 100 nm, and the length thereof is 1 μm to 100 μm.

In addition, as the mesh-shaped member 3, a fibrous member (extremely fine metallic fiber) such as silicon nanowires, silicon nanotubes, metal oxide nanotubes, carbon nanotubes, carbon nanofibers, graphite fibrils, or the like other than the above-described extremely fine metallic fiber 4 may be used, and these may be dispersed and connected.

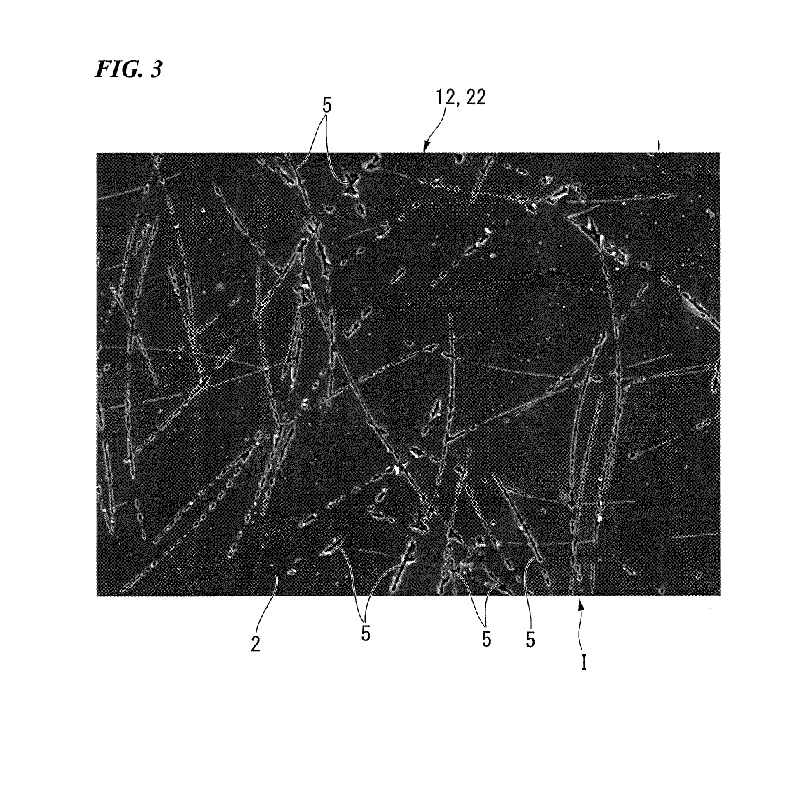

In addition, in the transparent substrate 2 of the transparent conductive films 12 and 22, an insulating portion I is formed by removing at least one part of the mesh-shaped member 3. That is, as shown in FIG. 3, a plurality of voids 5 are formed on the transparent substrate 2 by removing the extremely fine metallic fiber 4 of the mesh-shaped member 3, and a region in which the voids 5 are densely arranged is the insulating portion I. Specifically, the voids 5 are formed in such a manner that a region where the extremely fine metallic fibers 4 of the mesh-shaped member 3 are arranged is irradiated with a pulsed laser beam to thereby evaporate and remove the extremely fine metallic fibers 4.

As the pulsed laser beam, a so-called femtosecond laser beam that is an extremely short pulse laser beam having a pulse width shorter than 1 picosecond may be used. In addition, as the pulsed laser beam, a YAG laser beam or a YVO₄ laser beam other than the femtosecond laser beam may be used. When using the YAG laser beam or the YVO₄ laser beam, a pulsed laser beam which has a pulse width of about 5 to 300 nanoseconds and is generally widely used as a processing machine may be used.

The voids 5 respectively form an elongated hole shape (an elongated round hole shape) or a hole shape (a round hole shape) so as to be irregularly extended or interspersed in mutually different directions along the surface direction of the surface (an exposed surface) of the transparent substrate 2, and are formed having an opening portion on the surface. Specifically, the voids 5 are arranged so as to correspond to a position where the evaporated and removed extremely fine metallic fibers 4 are arranged, and has a diameter (an inner diameter) substantially equal to a diameter of the extremely fine metallic fiber 4 and a length shorter than a length of the extremely fine metallic fiber 4.

More specifically, by completely evaporating and removing a single extremely fine metallic fiber 4 or by completely evaporating and removing at least one part, the extremely fine metallic fibers 4 are divided in their extending direction, and therefore the plurality of voids 5 are formed with a space provided therebetween. That is, to correspond to an equivalent position of the extremely fine metallic fibers 4, the plurality of voids 5 which are separated from each other are extended or interspersed so as to form a dotted line shape as a whole. In addition, to correspond to the equivalent position of the single extremely fine metallic fiber 4, only one void 5 may be formed so as to form a linear shape.

In the insulating portion I, by forming the voids 5, the extremely fine metallic fiber 4 that is a conductor is removed, and the above-described conductive 2D network is removed (disappears).

In this manner, by removing the extremely fine metallic fiber 4 from the transparent substrate 2 in the insulating portion I, chemical compositions of the conductive portion C and the insulating portion I on the transparent substrate 2 are different from each other.

Next, a manufacturing device for manufacturing the transparent conductive film and conductive substrate of the input member 1 of the input device according to the present embodiment and a manufacturing method will be described.

In the manufacturing method of a conductive pattern formation substrate (a conductive substrate), a method is used in which a transparent conductive layer “a” (a transparent conductive film before forming a conductive pattern) formed on one side of the insulating substrate 11 (21) is irradiated with a laser beam L of an extremely short pulse in a predetermined pattern.

In addition, in the following description, a laminated body having the insulating substrate 11 (21) before a laser processing and the transparent conductive layer “a” formed on one side of the insulating substrate 11 (21) is referred to as a laminated body A for a conductive substrate.

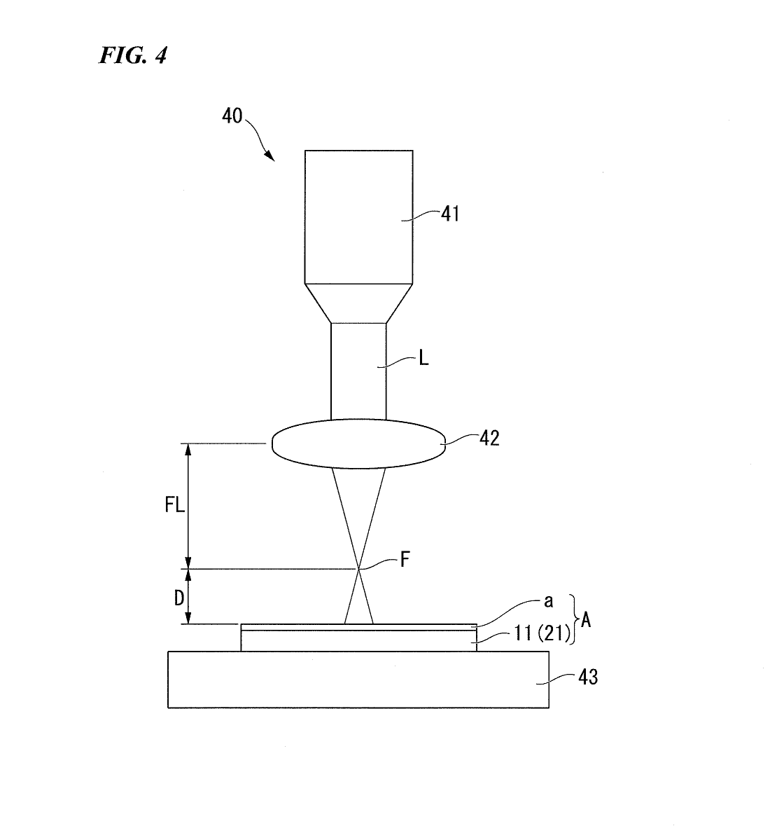

First, a manufacturing device 40 that is used in the manufacturing method of the conductive pattern formation substrate of the present embodiment will be described. As shown in FIG. 4, the manufacturing device 40 includes a laser beam generating means 41 that generates a laser beam L, a condensing lens 42 such as a convex lens or the like that is a light condensing means for condensing the laser beam L, and a stage 43 in which the laminated body A for the conductive substrate is positioned.

As the laser beam generating means 41 in the manufacturing device 40, a laser beam generating means 41 that generates a laser beam (a laser beam of visible light or infrared light) having a wavelength of less than 2 μm and a pulse width of less than 200 nanoseconds may be used. In addition, on the point of being easily usable, it is preferable that the pulse width of the laser beam L be 1 to 100 nanoseconds.

It is preferable that the condensing lens 42 be arranged so that a focal point F of the laser beam L between the transparent conductive layer “a” and the condensing lens 42 is located. Therefore, a spot diameter of the laser beam L corresponding to the insulating substrate 11 (21) and the stage 43 becomes larger than a spot diameter of the laser beam L corresponding to the transparent conductive layer “a”, and an energy density of the laser beam L corresponding to the insulating substrate 11 (21) and the stage 43 becomes smaller, thereby preventing damage to the insulating substrate 11 (21) and the stage 43.

As the condensing lens 42, it is preferable that a condensing lens having a small number of openings (NA<0.1) be used. That is, when the number of openings of the condensing lens 42 is NA<0.1, setting the irradiation conditions of the laser beam L is facilitated, and it is possible to prevent an energy loss and diffusion of the laser beam L due to generation of plasma from air at the focal point F when the focal point F of the laser beam L is positioned between the transparent conductive layer “a” and the condensing lens 42.

In addition, when the transparent conductive layer “a” is formed by filling (impregnating) the transparent substrate 2 made of resin between fibers (element wires) of the mesh-shaped member 3 formed from the extremely fine metallic fiber 4 and is formed on the insulating substrate 11 (21) formed of a transparent resin film, the extremely fine metallic fiber 4 that is embedded in the transparent substrate 2 of the transparent conductive layer “a” may be reliably removed by ejecting from the surface of the transparent substrate 2 by the above-described setting. Accordingly, the voids 5 may be reliably formed corresponding to a desired shape of the insulating portion I, and an insulation process may be reliably and easily achieved.

In addition, an irradiation spot where the laser beam L is irradiated on the transparent conductive layer “a” is formed in a planar shape rather than a punctuate shape, and therefore a control of an irradiation energy density so as not to affect the insulating substrate 11 (21) is easily performed compared to the conventional method while the transparent conductive layer “a” is processed. Furthermore, it is possible to draw, as a batch, an insulating pattern having a thick line width with respect to the transparent conductive layer “a”, a so-called fill-processing may be facilitated, and the width of the insulating pattern may be large, and therefore the insulating property of the insulating portion I may be improved.

In addition, the stage 43 may be moved in the horizontal direction in a 2D manner. It is preferable that the stage 43 be composed of a member whose at least upper surface side is transparent or a member having a light absorbing property.

When the insulating substrate 11 (21) is transparent and the output of the laser beam L exceeds 1 W, it is preferable that the stage 43 use a nylon-based or fluorine-based resin material or a silicon rubber-based polymer material.

Next, the manufacturing method of the conductive pattern formation substrate of the input member 1 of the input device using the above-described manufacturing device 40 will be described.

First, the laminated body A for the conductive substrate is disposed on an upper surface of the stage 43 so that the transparent conductive layer “a” is disposed above the insulating substrate 11 (21).

Next, the laser beam L is condensed by the condensing lens 42 by emitting the laser beam L from the laser beam generating means 41. The transparent conductive layer “a” is irradiated with a part of the condensed laser beam L where a spot diameter is widened passing through a focal point F. In this instance, the stage 43 is moved so that the irradiation of the laser beam L becomes a predetermined pattern.

The energy density of the laser beam L irradiated on the transparent conductive layer “a” and the irradiation energy per unit area may differ depending on the pulse width of a laser beam.

In a laser beam (for example, a femtosecond laser beam) having a pulse width shorter than 1 picosecond, it is preferable that the energy density be 1×10¹⁶ to 7×10¹⁷ W/m², and the irradiation energy per unit area be 1×10⁵ to 1×10⁶ J/m².

In a laser beam (YAG laser beam or YVO₄ laser beam) having a pulse width of 1 to 100 ns, it is preferable that the energy density be 1×10¹⁷ to 7×10¹⁸ W/m², and the irradiation energy per unit area be 1×10⁶ to 1×10⁷ J/m².

That is, when the energy density and the irradiation energy are set as a value smaller than the above-described numerical range, there is a possibility that insulation of the insulating portion I becomes insufficient. In addition, when the energy density and the irradiation energy are set as a value larger than the above-described numerical range, a machining mark becomes noticeable, and is unsuitable for applications such as the transparent touch panel, a transparent electromagnetic shielding, or the like.

In addition, these values are defined by dividing the output value of the laser beam in a processing area by the condensing spot area of the processing area, and conveniently, the output may be obtained by multiplying the output value from a laser oscillator by the loss coefficient of an optical system.

In addition, a spot diameter area S is defined by the following Equation.

S=Sₒ×D/FL

S₀: beam area of laser beam condensed in lens

FL: focal distance of lens

D: distance between surface (upper surface) of transparent conductive layer “a” and focal point

Here, the distance D is set in a range of 0.2% to 3% of the focal distance FL. Preferably, the distance D is set in a range of 0.5% to 2% of the focal distance FL. More preferably, the distance D is set in a range of 0.7% to 1.5% of the focal distance FL. By setting the distance D in the above-described range, the removal (formation of the voids 5) of the extremely fine metallic fiber 4 in the insulating portion I may be reliably performed, the insulating pattern (conductive patter) having electrically high reliability may be formed, and a machining mark due to the damage to the insulating substrate 11 (21) may be reliably prevented.

In addition, in terms of forming a conductive pattern with high accuracy, it is preferable that a portion where adjacent spot positions are overlapped be formed by intermittently irradiating the pulsed laser beam L a plurality of times while moving the position of the spot on the transparent conductive layer “a”. Specifically, it is preferable that the portion be formed by intermittently irradiating the pulsed laser beam L 3 to 500 times, and it is more preferable that the portion be formed by intermittently irradiating the pulsed laser beam L 20 to 200 times. When irradiation is performed at least three times, insulation may be more reliably achieved, and when irradiation of at least 500 times is performed, the removal due to partial dissolution and evaporation of the transparent substrate 2 irradiated with the laser beam L may be prevented.

In this manner, patterning is applied to the transparent conductive layer “a”, the transparent conductive film 12 (22) including the conductive pattern composed of the conductive portion C and the insulating portion I is formed, and the laminated body A for the conductive substrate becomes the conductive pattern formation substrate (conductive substrate) 10 (20).

In addition, in the above description, the patterning is performed by placing the laminated body A for the conductive substrate on a movable stage 43 such as an XY stage, but the invention is not limited thereto. That is, the patterning may be performed using a method of relatively moving a condensing system member in a state in which the laminated body A for the conductive substrate is fixed, a method of scanning the laser beam L using a galvanometer mirror or the like, or combination of the above-described methods.

The laminated body A for the conductive substrate that is used in the above-described manufacturing method is a laminated body shown below.

Among the transparent conductive layers a of the laminated body A for the conductive substrate, as an inorganic conductor constituting the mesh-shaped member 3, metallic nanowires such as silver, gold, nickel, or the like may be used. In addition, among the transparent conductive layers a, as an insulator constituting the transparent substrate 2, transparent thermoplastic resin (polyvinyl chloride, vinyl chloride-vinylacetate copolymers, poly methyl methacrylate, nitrocellulose, chlorinated polyethylene, chlorinated polypropylene, and vinylidene fluoride), and transparent curable resin (melamine acrylate, urethane acrylate, epoxy resin, polyimide resin, silicon resin such as acrylic-modified silicate) that is cured by heat, ultraviolet rays, electron rays, radiation, or the like may be used.

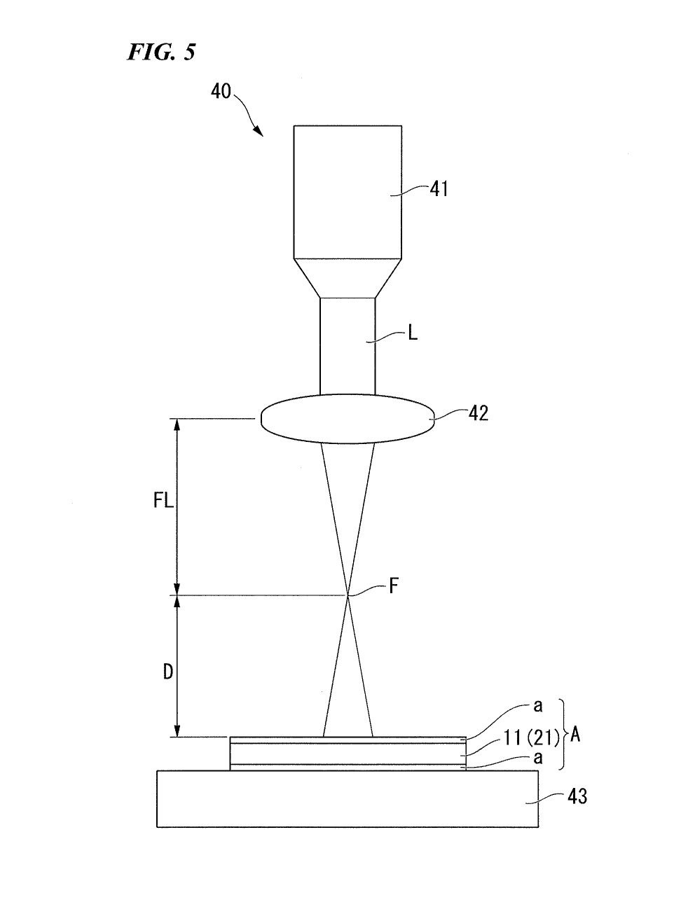

In addition, FIG. 5 is a modification example of the present embodiment, and in the shown example, a pair of transparent conductive layers a are provided on both upper and lower surfaces of the insulating substrate 11 (21) in the laminated body A for the conductive substrate. In this case, when using the condensing lens 42 in which a focal distance FL is at least 50 mm and the number of openings is less than 0.2, the spread of the laser beam L may be reduced. Therefore, positional adjustment of the lens is facilitated, a difference in spot diameters on both surfaces of the insulating substrate 11 (21) is reduced, and the energy densities corresponding to both the transparent conductive layers a are substantially equal to each other. As a result, the same insulating pattern may be formed as a batch on both surfaces of the transparent conductive layers a.

In addition, among the transparent conductive layers a formed on both surfaces of the insulating substrate 11 (21), the condensing lens 42 in which the number of openings is larger than 0.5 may be used when insulating only one surface side of the transparent conductive layer “a”.

As described above, by the input device according to the present embodiment, in the transparent substrate 2 of the transparent conductive film 12 (22) of the input member 1, a disposition region of the mesh-shaped member 3 having conductivity becomes the conductive portion C, and a disposition region of the voids 5 formed by removing the mesh-shaped member 3 becomes the insulating portion I. That is, in the conductive portion C, conduction may be ensured by the mesh-shaped member 3 made of a metal, and in the insulating portion I, an electrical insulation state may be reliably obtained by the voids 5 formed by removing the mesh-shaped member 3.

Specifically, in the conventional transparent conductive film, the mesh-shaped member 3 made of metallic nanowires which are dispersed electrically connected in the transparent substrate 2 remains in the insulating portion I as along with the conductive portion C, and therefore it is difficult to reliably perform insulation on the insulating portion I. Meanwhile, by the configuration of the present embodiment, the mesh-shaped member 3 (extremely fine metallic fibers 4) of the insulating portion I is removed so as to be replaced with the voids 5, and the insulating portion I is reliably insulated, and therefore a stable electrical property (performance) in the transparent conductive film 12 (22) may be obtained, and reliability as a product (input device) may be enhanced.

In addition, in the insulating portion I, the voids 5 having a shape equivalent to (corresponding to) the mesh-shaped member 3 (extremely fine metallic fibers 4) are formed by removing the mesh-shaped member 3. That is, by forming the voids 5, color tones and transparency of the conductive portion C and the insulating portion I approximate each other, and cannot be distinguished from one another (visible) with the naked eye or the like. Accordingly, a wiring pattern never be visible even though a width of the insulating portion I is increased.

In addition, since the mesh-shaped member 3 is formed of the extremely fine metallic fibers 4 which are dispersed in the transparent substrate 2 and are electrically connected with each other, the mesh-shaped member 3 may be relatively easily formed using the extremely fine metallic fibers 4 such as commercially available metallic nanowires or metallic nanotubes.

In addition, as in the present embodiment, when silver is used as a main component in the extremely fine metallic fibers 4, the extremely fine metallic fibers 4 may be relatively easily obtained and used as the mesh-shaped member 3. In addition, when the mesh-shaped member 3 (the extremely fine metallic fibers 4) of the insulating portion I is removed by laser processing, a commercially available general laser processing machine is compatible. In addition, more preferably, the extremely fine metallic fibers 4 containing silver as a main component may form a colorless transparent conductive pattern having high light transmittance and low surface resistivity.

In addition, as a laser processing machine (manufacturing device) 40, it is more preferable when using an extremely short pulse laser beam having a pulse width shorter than 1 picosecond, a conductive pattern (insulating pattern) in the conductive substrate 10 (20) after the laser processing may be reliably visually not observed.

In this manner, by the transparent conductive film 12 (22) of the present embodiment and the conductive substrate 10 (20) using the transparent conductive film 12 (22), the conductive pattern is hardly visible, the insulating portion I is reliably insulated while the conductive portion C in the conductive pattern has low resistance, and a stable electrical performance may be obtained.

In addition, in the present embodiment, the insulating substrates 11 and 21 are both transparent, but any one or both of the insulating substrates 11 and 21 may be subjected to coloring having a certain degree of transparency.

In addition, the mesh-shaped member 3 is formed of a plurality of extremely fine metallic fibers 4 which are dispersed in the transparent substrate 2 and electrically connected with each other, but the invention is not limited thereto. That is, the mesh-shaped member 3 may be a wire grid obtained by forming the metallic film having conductivity into a lattice by etching or the like.

In addition, a functional layer such as adhesion, antireflection, hard coating, a dot spacer, or the like may be arbitrarily added to the conductive substrates 10 and 20.

In particular, a laser beam having a wavelength of about 1000 nm such as fundamental waves of a YAG laser beam or a YVO₄ laser beam is used, and when using an acrylic polymer material as the above-described functional layer, the functional layer may be provided after laser beam irradiation from the viewpoint of appearance properties.

### Second Embodiment

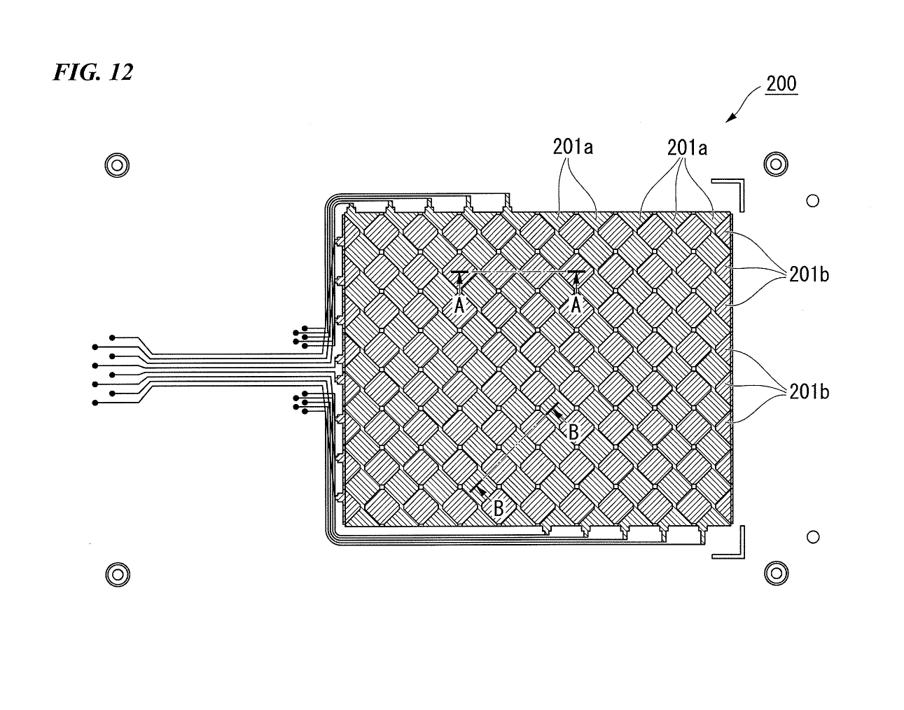

Next, an input device according to a second embodiment of the invention will be described with reference to FIGS. 12 to 16. In addition, the same reference numerals are used to designate the same or similar components, and redundant descriptions thereof are omitted.

the input device according to the present embodiment is a capacitive touch panel. FIG. 12 shows an input member 200 for a capacitive touch panel (input device). The capacitive touch panel includes upper and lower electrodes (transparent conductive films 212 and 222) that are capacitively coupled with a human body part H such as a finger or the like through an insulating layer 240 disposed on a surface facing the side of the inputting person, applies AC signals to one electrode, and detects a contact condition of a finger by measuring the other electrode.

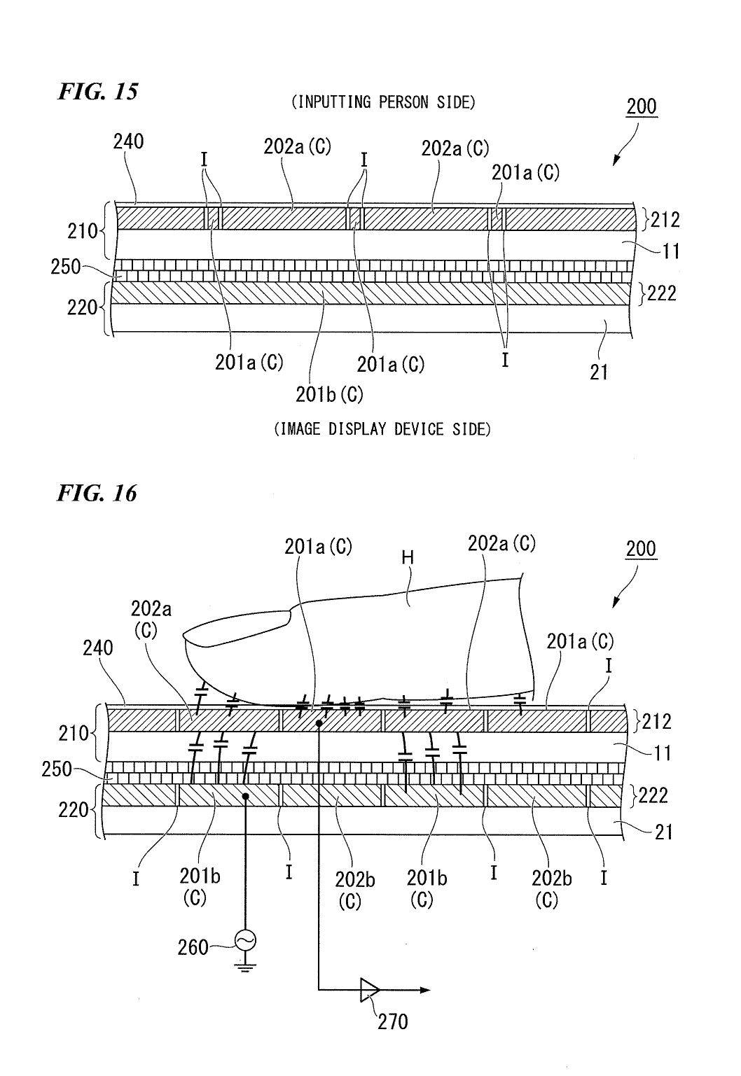

As shown in FIGS. 15 and 16, in the input member 200 of the capacitive touch panel, transparent conductive films 212 and 222 of a pair of electrode sheets 210 and 220 (conductive substrates) are respectively arranged towards one side (inputting person side) along the thickness direction (vertical direction of the drawing).

As shown in FIGS. 12 to 14, the input member 200 includes an X side electrode sheet 210 (conductive substrate) that forms an electrode 201 a having a checkered pattern (a state in which corners of squares having the same shape are connected, a so-called check pattern shape) and a Y side electrode sheet 220 (conductive substrate) that forms an electrode 201b having a checkered pattern complementary to the X side electrode sheet 210.

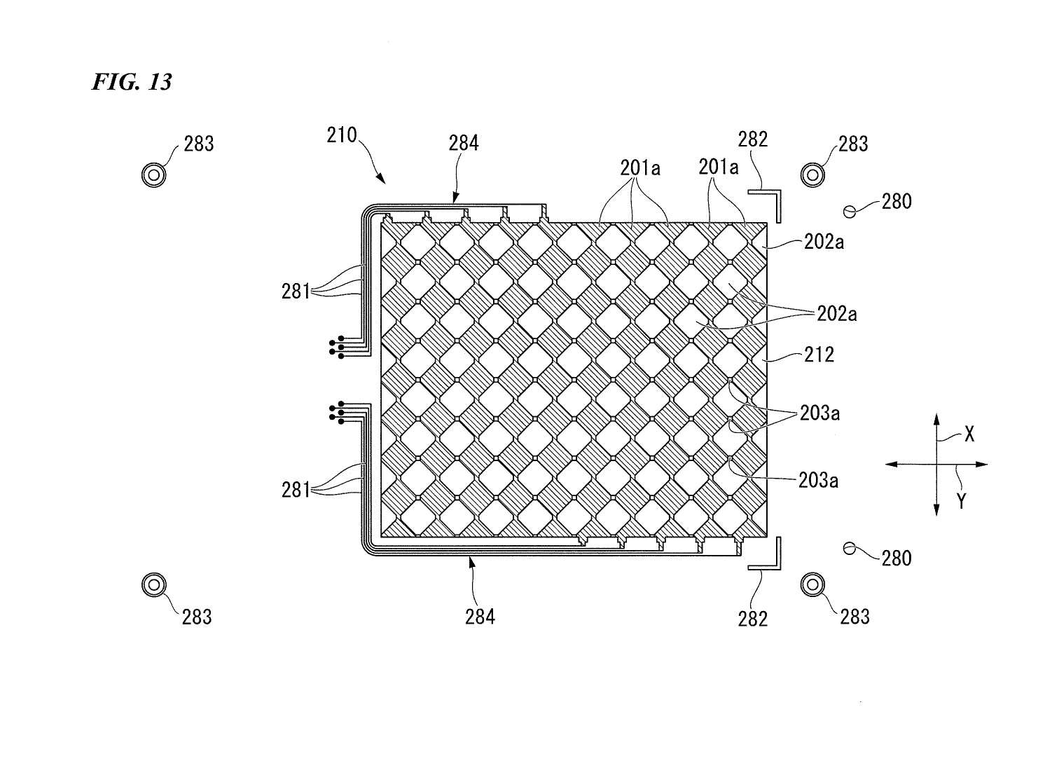

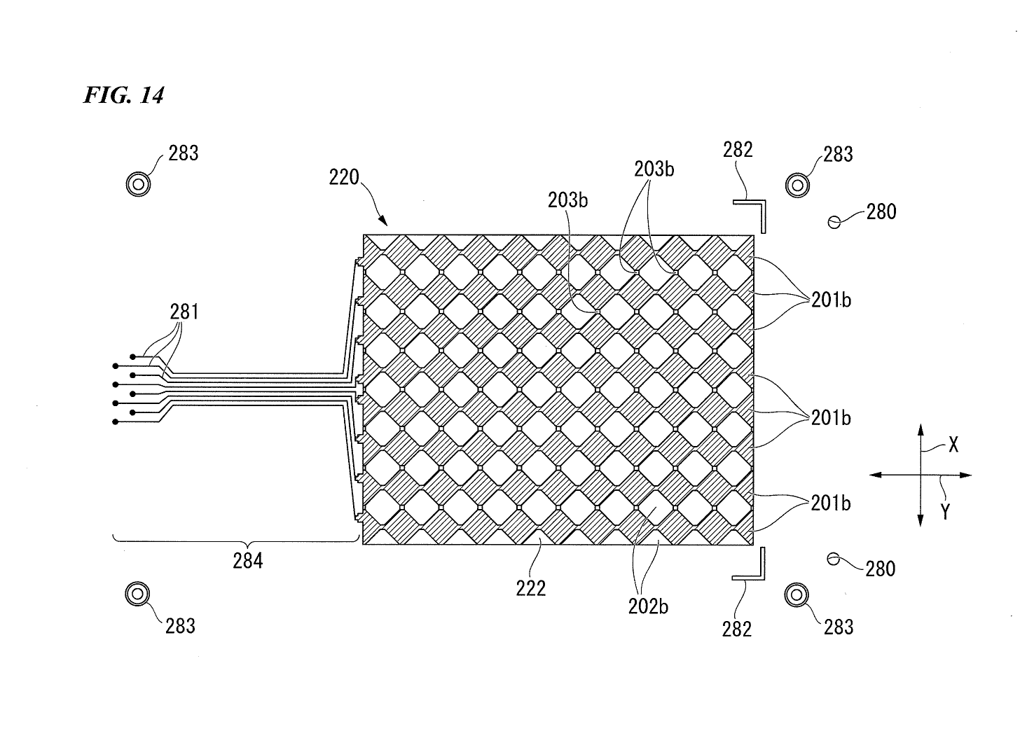

As shown in FIG. 13, the electrodes 201a are formed in such a manner that corners of a plurality of squares arranged along an X direction are electrically connected with each other and extended, and are arranged in parallel in a state in which the squares adjacent to each other in a Y direction are electrically insulated from each other in the Y direction. In addition, as shown in FIG. 14, the electrodes 201b are formed in such a manner that the corners of a plurality of squares arranged along the Y direction are electrically connected with each other and extended, and are arranged in parallel in the X direction in a state in which the squares adjacent to each other in the X direction are electrically insulated.

As shown in FIG. 12, the X side electrode sheet 210 and the Y side electrode sheet 220 are combined in a state of being disposed so as to oppose each other without allowing the electrodes 201a and 201b face each other in the thickness direction.

Specifically, as shown in FIGS. 15 and 16, the X side electrode sheet 210 is fixed so as to be laminated on an upper surface (a surface of the side of the inputting person) of the Y side electrode sheet 220 through a transparent adhesive material 250, and in this state, both the electrodes 201a and 201b are not overlapped with each other in the thickness direction.

In addition, as shown in FIGS. 13 and 16, in a transparent conductive film 212 of the X side electrode sheet 210, an isolated electrode 202a formed in a square shape is respectively formed in a region facing a square part in the electrode 201b of the Y side electrode sheet 220. In an outer periphery of the isolated electrode 202a, an insulating portion I formed in a square ring shape is formed by irradiating with the laser beam L.

In addition, in the transparent conductive film 212 of the X side electrode sheet 210, a small isolated electrode 203a formed in an outer small square from the isolated electrode 202a is formed between corners in which the squares of the electrodes 201a adjacent to each other in the Y direction face. In an outer periphery of the small isolated electrode 203a, the isolating portion I formed in a square ring shape is formed by irradiating with the laser beam L. That is, the isolated electrode 202a and the small isolated electrode 203a mutually share a part of the insulating portion I.

In addition, as shown in FIGS. 14 and 16, in the transparent conductive film 222 of the Y side electrode sheet 220, the isolated electrode 202b formed in a square shape is formed in a region facing a square part in the electrode 201a of the X side electrode sheet 210. In an outer periphery of the isolated electrode 202b, the insulating portion I formed in a square ring shape is formed by irradiating with the laser beam L.

In addition, in the transparent conductive film 222 of the Y side electrode sheet 220, a small isolated electrode 203b formed in an outer small square from the isolated electrode 202b is respectively formed between corners in which the squares of the electrodes 201b adjacent to each other in the X direction face. In an outer periphery of the small isolated electrode 203b, the isolating portion I formed in a square ring shape is respectively formed by irradiating with the laser beam L. That is, the adjacent isolated electrode 202b and the small isolated electrode 203b mutually share a part of the insulating portion I.

In the input member 200 configured as above, the mesh-shaped member 3 is arranged in the electrodes 201a and 201b and the isolated electrodes 202a and 202b, and becomes a conductive portion C. In addition, in the present embodiment, the small isolated electrodes 203a and 203b also become the conductive portion C, but the small isolated electrodes 203a and 203b may become the insulating portion Iformed in a square shape by irradiating the small isolated electrodes 203a and 203b with the laser beam L in a way as to smear away the small isolated electrodes 203a and 203b.

Next, an operation of a capacitive touch panel using the input member 200 will be described with reference to FIG. 16.

When a human body part H (a contact object) such as a finger or the like touches the input member 200 through the insulating layer 240 formed on a surface (a surface of the side of the inputting person), capacitive coupling is formed between the contact object H and each electrode. In this state, a voltage is applied to one electrode 201b of the Y side electrode sheet 220 using a signal line 260, and signals (input signals) of the electrode 201a of the X side electrode sheet 210 are detected by the detection means 270, and therefore it is possible to detect a contact condition between the contact object H and the input member 200.

By the input member 200 according to the present embodiment, the insulation property of the insulating portion I is sufficiently ensured, and therefore the above-described particular configuration may be adopted, and the following superior functions an effects may be obtained.

That is, when the contact object H contacts as described above, the electrode 201b of the Y side electrode sheet 220 and the contact object H may form capacitive coupling through the isolated electrode 202a of the X side electrode sheet 210 that is positioned on the electrode 201b. Due to this, the electrode 201a of the X side electrode sheet 210 and the electrode 201b of the Y side electrode sheet 220 are arranged in substantially the same layer (the transparent conductive film 212). Accordingly, the position of the contact object H may be detected with high accuracy.

Specifically, in the input member of the conventional capacitive touch panel, in the transparent conductive film 212 of the X side electrode sheet 210, an isolated electrode (a conductive portion C) is not provided in a region facing the electrode 201b of the Y side electrode sheet 220. In addition, in the transparent conductive film 222 of the Y side electrode sheet 220, the isolated electrode (a conductive portion C) is not provided even in a region facing the electrode 201a of the X side electrode sheet 210. In the above-described configuration, the electrodes 201a and 201b are simply kept in an insulation state, and strict control of the interval between one another to a certain width is required. That is, in the conventional configuration, accuracy of a distance between the upper and lower electrodes 201a and 201b easily affects the detection result, and an area where an insulation process is performed is relatively large.

Meanwhile, according to the present embodiment, since the electrodes 201a and 201b are disposed in substantially the same layer (planar surface), the detection accuracy is improved without the need for accuracy of the distance between the conventional upper and lower electrodes 201a and 201b.

In addition, an area of a region (insulating portion I) where an insulation process is performed is significantly reduced, and productivity is improved.

In addition, chemical compositions of the electrodes 201a and 201b of the isolated electrodes 202a and 202b are the same, and therefore a conductive pattern is less likely to be recognized, and the appearance is good.

In addition, the small isolated electrodes 203a and 203b are formed, and therefore the influence on the detection accuracy due to the time of the contact of the contact object H and assembly tolerances may be further reduced.

### EXAMPLES

Hereinafter, the invention will be described in detail using examples. However, the invention is not limited to the examples.

### Manufacturing Example 1

### Manufacturing of Silver Nanowires and Conductive Film (Conductive Substrate) Which are Used in Input Member of Input Device (Example of the Invention)

Ohm's (trade name) ink (extremely fine metallic fiber 4) manufactured by Cambrios was applied to a transparent polyester (PET) film (insulating substrates 11 and 21) having a thickness of 100 μm and dried, ultraviolet curable polyester resin (transparent substrate 2) was overcoated, and then was subjected to drying and ultraviolet treatment, thereby forming, on the PET film, a transparent conductive layer having an abrasion resistance and having a conductive 2D network (mesh-shaped member 3) formed of silver fibers (extremely fine metallic fibers 4) having a wire diameter of 50 nm and a length of 15 μm (FIG. 2).

The surface resistivity of the transparent conductive layer “a” of the silver nanowire conductive films (conductive substrates 10 and 20) was 230 Ω/□, and the light transmittance was 95%.

Next, the silver nanowires conductive film was subjected to a cutting process so as to be formed in a rectangular shape with a length of 210 mm and a width of 148 mm to thereby obtain the silver nanowires conductive film test piece.

### Manufacturing Example 2

### Manufacturing of Silver Deposited Conductive Film of Input Member of Input Device (Comparative Example)

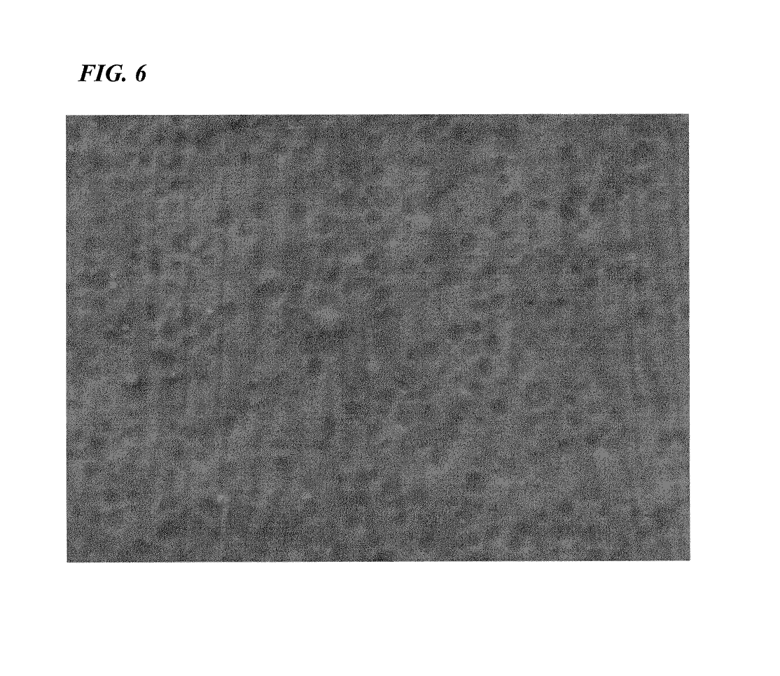

A test piece in which a silicone acrylic hard coating layer was provided on one side surface of a transparent PET film with a thickness of 100 μm was prepared, and a zinc oxide film with a thickness of 60 nm was formed on a surface opposite to the hard coating layer by a magnetron sputtering device. Next, a silver film with a thickness of 27 nm was formed on a surface of the zinc oxide film using the magnetron sputtering device. In addition, in the same manner as that of the zinc oxide film, a zinc oxide film with a thickness of 60 nm was formed on a surface of the silver film (FIG. 6). Thus, a transparent conductive layer having a conductive 2D network formed of the zinc oxide film and the silver film was formed on the PET film. Specifically, as shown in FIG. 6, a silver deposited layer (silver film) was densely connected to a plurality of granules, and was formed so that a slight gap was provided.

The surface resistivity of the transparent conductive layer of the silver deposited conductive film was 95 Ω/□, and the light transmittance was 85%.

Next, the silver deposited conductive film was subjected to a cutting process so as to be formed in a rectangular shape with a length of 210 mm and a width of 148 mm to thereby obtain the silver deposited conductive film test piece.

### Experimental Example 1

A femtosecond laser beam (manufacturing device 40) with a wavelength of 750 nm, an output of 10 nW, a pulse width of 130 fs, a repetition frequency of 1 kHz, and a beam diameter of 5 mm was used, a test piece was placed on a glass plate having a thickness of 5 mm using a condensing lens 42 with a focal distance FL=100 mm and a galvanometer mirror so that the transparent conductive layer faces an opposite side of the glass plate, a focal point F of the laser beam L was adjusted so as to be set in a position that is separated by 1.5 mm from the surface of the transparent conductive film in the test piece towards the condensing lens 42, and then the condensed point was moved at 1 mm/s so as to be cut in a width direction of the test piece to be subjected to straight line drawing (formation of insulating pattern).

### Experimental Example 2

A focal point F of the laser beam L was subjected to straight line drawing under the same condition as that of experimental example 1 except that the focal point F was formed on the surface of the transparent conductive layer.

### Experimental Example 3

A YVO₄ laser beam (manufacturing device 40) with a wavelength of 1064 nm, an output of 12 W, a pulse width of 20 ns, a repetition frequency of 100 kHz, and a beam diameter of 6.7 mm was used, a test piece was placed on a Duracon (registered trademark) plate having a thickness of 5 mm using a condensing lens 42 with a focal distance FL=300 mm and a galvanometer mirror so that the transparent conductive layer faces an opposite side of the Duracon (registered trademark) plate, a focal point F of the laser beam L was adjusted so as to be set in a position that is separated by 3 mm from the surface of the transparent conductive film in the test piece towards the condensing lens 42, and then the condensed point was moved at 100 mm/s so as to be cut in a width direction of the test piece to be subjected to straight line drawing (formation of insulating pattern).

### Experimental Example 4

Straight line drawing was performed under the same conditions as that of experimental example 3 except that a moving speed of the condensed point was 300 mm/s.

### Experimental Example 5

Straight line drawing was performed under the same conditions as that of experimental example 3 except that a moving speed of the condensed point was 300 mm/s and an output was 3.6 W.

### Experimental Example 6

A focal point F of the laser beam L was subjected to straight line drawing under the same condition as that of experimental example 4 except that the focal point F was formed on the surface of the transparent conductive layer.

### Experimental Example 7

Straight line drawing was repeatedly performed five times in the same position under the same condition as that of experimental example 4.

### Experimental Example 8

A carbon dioxide laser beam (continuous oscillation) with a wavelength of 10.6 μm and an output of 15 W was used, a test piece was placed on a glass plate having a thickness of 5 mm using a condensing lens 42 with a focal distance FL=300 mm and a galvanometer mirror so that the transparent conductive layer faces an opposite side of the glass plate, a focal point F of the laser beam L was adjusted so as to be set in a position that is separated by 3 mm from the surface of the transparent conductive layer in the test piece towards the condensing lens 42, and then the condensed point was moved at 300 mm/s so as to be cut in a width direction of the test piece to thereby be subjected to straight line drawing.

With respect to the electrode pattern formation substrate (conductive substrate) obtained by the above-described experiments, an electrical resistance value was measured interposing a portion irradiated with the laser beam L using a tester. In addition, visibility of the conductive pattern (machining mark) was evaluated by visual inspection. The evaluation results are shown in Table 1.

In addition, criteria (A, B, C, and D) of the evaluation were as shown below.

A: excellent, when an electrical resistance value exceeds 10 MΩ, insulation is reliably achieved and a conductive pattern is not visible at all

B: good, when an electrical resistance value exceeds 10 MΩ, insulation is reliably achieved and a conductive pattern is hardly visible (when assembling the touch panel, a machining mark is not substantially visible)

C: satisfactory when an electrical resistance value exceeds 10 MΩ, insulation is reliably achieved but the conductive pattern is visible (when assembling the touch panel, a level capable of being used as a product (input member 1 of input device))

D: unsatisfactory, when an electrical resistance value is equal to or less than 10 MΩ and insulating is insufficient, or scorching or holes are formed to a degree visible by visual inspection. In other words, unable to be used as a product (input member 1 of the input device)

TABLE 1

| Irradiation | Examples | | | | | | | |
|---|---|---|---|---|---|---|---|---|
| conditions | 1 | 2 | 3 | 4 | 5 | 6 | 7 | 8 |
| Laser | Femtosecond laser | | YVO₄ laser | | | | | Carbon |
| processing | | | | | | | | dioxide laser |
| machine | | | | | | | | (continuous |
| | | | | | | | | oscillation) |
| Wavelength | 750 nm | | 1064 nm | | | | | 10 μm |
| Output | 10 mW | | 12 W | | 3.6 W | 12 W | | 15 W |
| Focal distance | 100 mm | | 300 mm | | | | | 300 mm |
| (FL) | | | | | | | | |
| Distance (D) | 1.5 mm | 0 mm (on | 3 mm | | | 0 mm (on | 3 mm | 3 mm |
| from surface of | | surface) | | | | surface) | | |
| transparent | | | | | | | | |
| conductive | | | | | | | | |
| layer to focal | | | | | | | | |
| point | | | | | | | | |
| Moving speed | 1 | | 100 | 300 | | | | 300 |
| of condensed | mm/second | | mm/second | mm/second | | | | mm/second |
| point | | | | | | | | |
| Drawing | 1 | | 1 | | | | 5 | 1 |
| frequency | | | | | | | | |
| Evaluation of | A | C | B | D (without | D (without | C | B | D (specific |
| conductive | | | | being | being | | | machining |
| pattern of | | | | insulated) | insulated) | | | mark) |
| manufacturing | | | | | | | | |
| example 1 (the | | | | | | | | |
| invention) | | | | | | | | |
| Evaluation of | D (without | C | C | D (without | D (without | D (scorching) | C | — |
| conductive | being | | | being | being | | | |
| pattern of | insulated) | | | insulated) | insulated) | | | |
| manufacturing | | | | | | | | |
| example 2 (the | | | | | | | | |
| invention) | | | | | | | | |

As shown in Table 1, in experimental examples 1, 3, and 7 in manufacturing example 1 (example of the invention), transparency and a change in color tones of the irradiation region were not ascertained by an optical microscope. When observing the irradiation region using an electron microscope, only silver nanowires were evaporated from the transparent substrate 2 and the void 5 was formed was ascertained (FIG. 3). In particular, in experimental example 1, the change in the irradiation region was not seen at all, and excellent results were obtained. In addition, when observing the irradiation region in experimental examples 2 and 6, the transparent conductive layer “a” itself was removed from the PET film by ablation was ascertained.

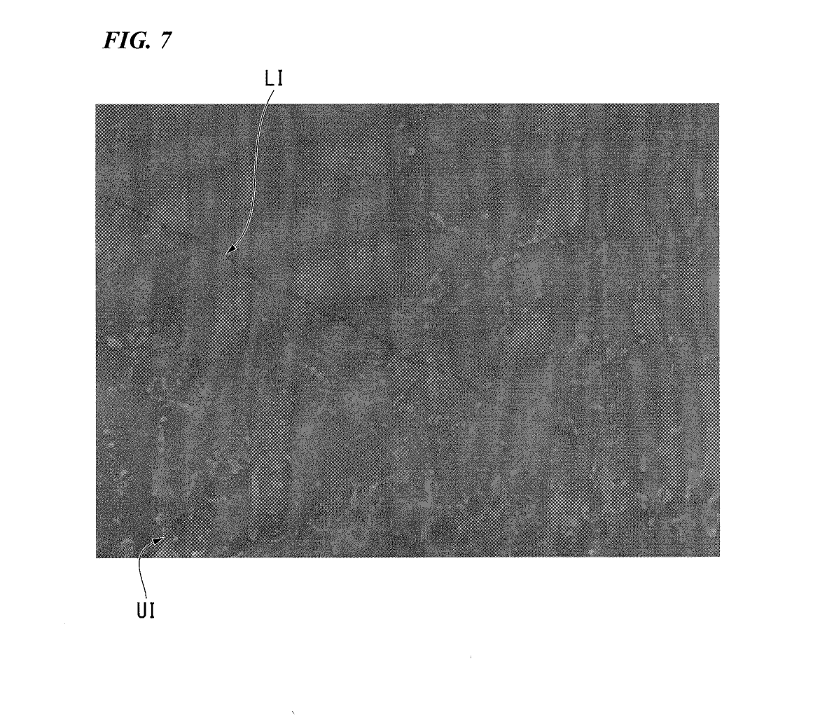

Meanwhile, in experimental examples 1 to 7 of manufacturing example 2 (comparative example), evaluations A and B were not obtained. In addition, in experimental examples 2, 3, and 7 of manufacturing example 2, the silver deposited layer on the surface of the PET film was extensively removed in the irradiation region (irradiation area shown by L1 of FIG. 7), and an insulating property was obtained was ascertained in opposition to a non-irradiated region (non-irradiated area shown by UI of FIG. 7) having conductivity.

In addition, in experimental example 8, a clear machining mark remained in the conductive pattern (evaluation D), and a level capable of being used as a product was not obtained.

### Manufacturing Example 3

### Manufacturing of Input Member 1 of Touch Panel (Input Device) (Example of the Invention)

Next, a manufacturing example of an input device 1 for a membrane-type touch panel (wiring substrate) of the invention using the above-described transparent conductive film and conductive film will be described.

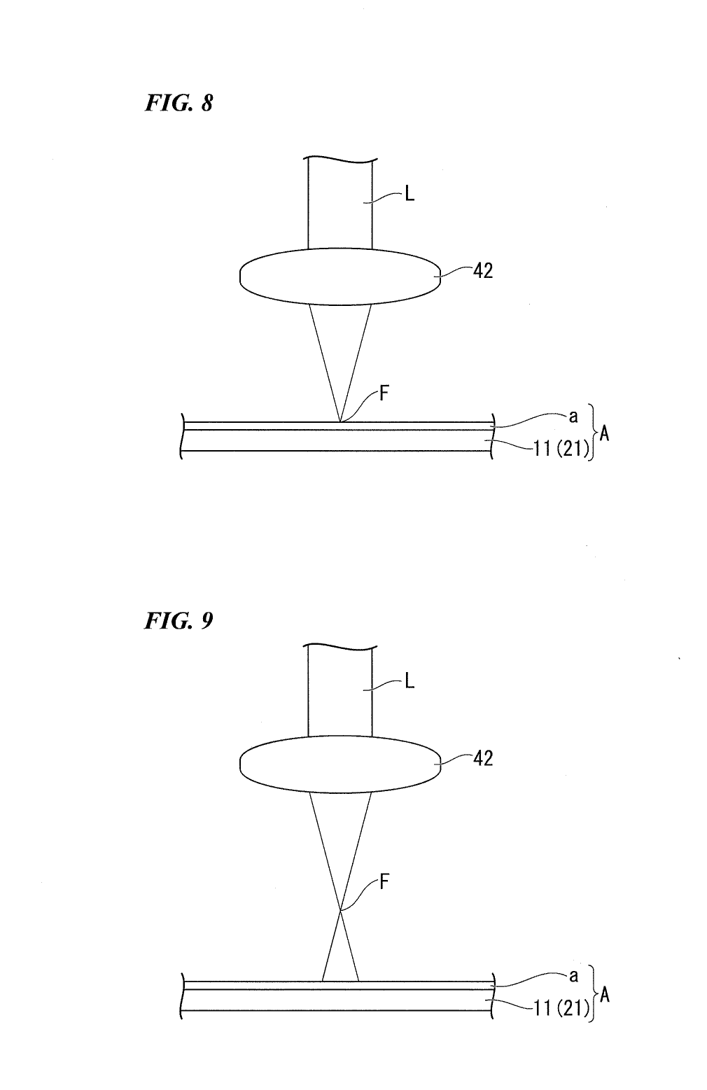

First, on the transparent conductive layer “a” of the laminated body A for a conductive substrate, commercially available silver paste was printed in a stripe shape by screen printing, and a connector pattern was formed. As shown in FIGS. 8 and 10, under the conditions of experimental example 2, six “+” marks each with 5 mm of a pitch and 1 mm of a length were as marks on the transparent conductive layer “a” were arranged in a row, two rows were marked with 25 mm of an interval provided between to thereby use as the mark of the input area.

Next, as shown in FIGS. 9 and 10, using “+” mark as a reference point, the wiring pattern in the input area was obtained by irradiating with six lines (laser beam L) each with 35 mm of a length under the irradiation condition of experimental example 1.

Next, using “+” mark as a reference point, the insulating pattern was formed in the form of intersecting a connector pattern under the conditions of experimental example 2, and a wiring substrate for the touch panel having a dimension of 25 mm×25 mm was obtained. In addition, when a pair of wiring substrates for the touch panel were prepared and ascertained by a test, in the wiring substrates for the touch panel, insulating between the wiring patterns in an end portion of the input area was achieved.

Next, as shown in FIG. 10, as a lead-out pattern 101, an Ag paste (Dotite (registered trademark) FA301CA: Fujikura Kasei Co., Ltd.) was formed by screen printing, and then using screen printing, a plurality of dot spacers 30 composed of acrylic resin with a diameter of 30 μm and a height of 8 μm were formed with a 1 mm pitch using “+” mark as a mark in one of these wiring substrates for the touch panel (see FIG. 1).

Next, the wiring substrate for the touch panel in which the dot spacer 30 was formed and the wiring substrate for the touch panel in which the dot spacer 30 was not formed are respectively cut out into a predetermined shape, the transparent conductive films 12 (22) are disposed so as to oppose each other, and therefore four corners were adhered using a commercially available double sided adhesive tape to thereby be used as the input member 1 (see FIG. 1) of the transparent membrane-type touch panel (input device).

### Evaluation

In the input member 1 of the touch panel manufactured as above, the dot spacer 30 and the wiring pattern were both not noticeable, and these acting as a key matrix was ascertained.

### Manufacturing Example 4

### Manufacturing of Input Member of Touch Panel (Comparative Example)

When patterning was performed on the laminated body A for the conductive substrate that prints the dot spacer 30 in advance, under the same conditions as those of manufacturing example 3, the color of the dot spacer 30 becoming black was ascertained by visual inspection.

### Manufacturing Example 5

### Manufacturing of Membrane-Type Touch Panel (Input Device) (Comparative Example)

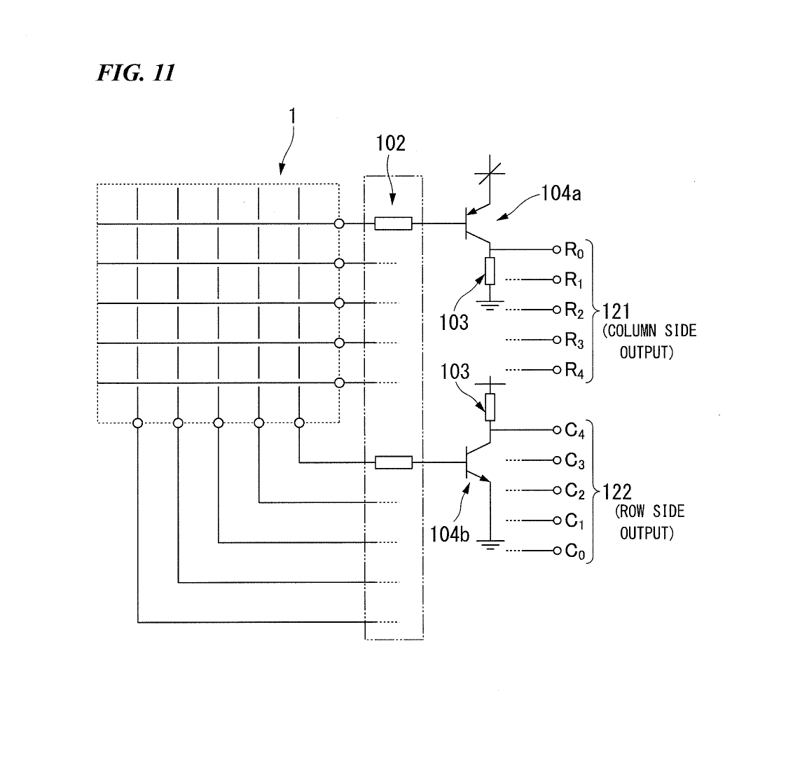

As shown in FIG. 11, an input device 1 for a membrane-type touch panel with five rows and five columns obtained in manufacturing example 3 was connected to ports 121 and 122 of 5 bit for each line side and row side using an interface circuit (detection means), and an output corresponding to pressing positions was obtained was ascertained.

In this instance, a current voltage was 5V, a current limitation resistor 102 was 3 kΩ, a pull-up and pull-down resistor 103 was 200Ω, and transistors 104a and 104b in a row direction and a column direction were about 200.

### Manufacturing Example 6

### Manufacturing of Capacitive Touch Panel (Input Device) (Example of the Invention)

Two silver nanowire conductive films of manufacturing example 1 were prepared. As shown in FIGS. 13 and 14, a guide pin hole 280 for positioning was formed in each silver nanowire conductive films. In addition, in the silver nanowire conductive films, an Ag paste (Dotite (registered trademark) FA301CA: Fujikura Kasei Co., Ltd.) was printed by screen printing, and then was subjected to drying at 100 degrees and for 15 minutes, thereby respectively forming a lead-out pattern 281.

Next, using the guide pin hole 280, the above-described silver nanowires and conductive films were fixed to the stage of an irradiation unit, and an outer mark 282 and a mark 283 for positioning a printing position were marked under the irradiation conditions of example 2.

In addition, in an Ag wiring pattern unit 284, the lead-out patterns 281 or an outer side thereof are irradiated in parallel in the extending direction of the pattern under the irradiation conditions of example 2 to thereby be insulated (0.1 mm space).

Next, under the irradiation condition of example 1, pattern irradiation was performed in the input area, thereby forming an insulating portion I.

Specifically, by forming the insulating portion I, in the silver nanowires and conductive films that are the X side electrode sheet 210 of FIG. 13, the electrode 201a extending along the X direction, an isolated electrode 202a surrounding the electrodes 201a adjacent to each other in the Y direction, and an isolated electrode 203a sandwiched between opposite corner portions of a square of the electrode 201a adjacent to each other in the Y direction were formed.

In addition, in the silver nanowires and conductive films that is the Y side electrode sheet 220 shown in FIG. 14, the electrode 201b extending along the Y direction, an isolated electrode 202b surrounding the electrodes 201b adjacent to each other in the X direction, and an isolated electrode 203b sandwiched between opposite corner portions of a square of the electrode 201b adjacent to each other in the X direction were formed.

Next, in order to provide the insulating layer 240 on a surface of the silver nanowires and conductive films that is the X side electrode sheet 210, the input area was coated by applying ultraviolet curable polyester resin ink made of pentaerythritol triacrylate, and cured.

Next, by cutting these silver nanowires and conductive films, X side and Y side electrode sheets 210 and 220 were obtained.

Next, the X side electrode sheet 210 and the Y side electrode sheet 220 were adhered using a transparent adhesive sheet (adhesive material 250) so that the electrodes 201a and 201b were projected in the form of being combined in a checkered pattern through the isolated electrodes 202a and 202b on the surface of the input member 200, thereby obtaining the input member 200 of the capacitive touch panel (input device).

In the input member 200 manufactured in this manner, the wiring pattern may not be visually ascertained in the input area, and therefore the excellent appearance may be obtained.

Next, a capacitive touch panel interface (CY8C24094: manufactured by Cypress) as the detection means 270 is electrically brought into contact with the input member 200, and operations by a finger H are satisfactorily performed.

### REFERENCE SIGNS LIST

1, 200: input member

2: transparent substrate

3: mesh-shaped member

4: extremely fine metallic fiber

5: void

10, 20: conductive substrate

11, 21: insulating substrate

12, 22, 212, 222: transparent conductive film

100: electrode (conductive portion)

201a, 201b: electrode (conductive portion)

202a, 202b: isolated electrode (conductive portion)

210: X side electrode sheet (conductive substrate)

220: Y side electrode sheet (conductive substrate)

270: detection means

C: conductive portion

I: insulating portion

1. An input device comprising:
an input member in which a pair of conductive substrates including an insulating substrate and a transparent conductive film that is provided on the insulating substrate and has a mesh-shaped member made of a conductive metal in an insulating transparent body are provided so as to be laminated in a thickness direction; and
a detection means for being electrically connected to the transparent conductive film, and detecting an input signal, wherein a conductive portion in which the mesh-shaped member is arranged in the transparent substrate and an insulating portion in which a void formed by removing the mesh-shaped member in the transparent substrate is arranged are provided on the transparent conductive film.

2. (canceled)

3. The input device according to claim 1, wherein the mesh-shaped member is formed of extremely fine metallic fibers that are dispersed in the transparent substrate and electrically connected with each other.

4. The input device according to claim 3, wherein the extremely fine metallic fibers contain silver as a main component.

5. The input device according to claim 1, wherein the void of the insulating portion is formed in such a manner that the mesh-shaped member is irradiated with a pulsed laser beam.

6. The input device according to claim 5, wherein the pulsed laser beam is an extremely short pulse laser beam having a pulse width shorter than 1 picosecond.

7. The input device according to claim 5, wherein the pulsed laser beam is a YAG laser beam or a YVO₄ laser beam.

8. The input device according to claim 1, wherein the insulating substrate is transparent.

9. The input device according to claim 1, wherein in the input member, the transparent conductive films of the pair of conductive substrates are respectively arranged toward the same side of the conductive substrates, and the detection means is a capacitive detection means.

10. The input device according to claim 1, wherein in the input member, the transparent conductive films of the pair of conductive substrates are disposed in close proximity with each other so as to oppose each other with a space provided therebetween, and parts of the transparent conductive film are electrically brought into contact with each other by an input operation.

11. The input device according to claim 3, wherein in the input member, the transparent conductive films of the pair of conductive substrates are disposed in close proximity with each other so as to oppose each other with a space provided therebetween, and parts of the transparent conductive film are electrically brought into contact with each other by an input operation.

12. The input device according to claim 4, wherein in the input member, the transparent conductive films of the pair of conductive substrates are disposed in close proximity with each other so as to oppose each other with a space provided therebetween, and parts of the transparent conductive film are electrically brought into contact with each other by an input operation.

13. The input device according to claim 5, wherein in the input member, the transparent conductive films of the pair of conductive substrates are disposed in close proximity with each other so as to oppose each other with a space provided therebetween, and parts of the transparent conductive film are electrically brought into contact with each other by an input operation.

14. The input device according to claim 6, wherein in the input member, the transparent conductive films of the pair of conductive substrates are disposed in close proximity with each other so as to oppose each other with a space provided therebetween, and parts of the transparent conductive film are electrically brought into contact with each other by an input operation.

15. The input device according to claim 7, wherein in the input member, the transparent conductive films of the pair of conductive substrates are disposed in close proximity with each other so as to oppose each other with a space provided therebetween, and parts of the transparent conductive film are electrically brought into contact with each other by an input operation.

16. The input device according to claim 8, wherein in the input member, the transparent conductive films of the pair of conductive substrates are disposed in close proximity with each other so as to oppose each other with a space provided therebetween, and parts of the transparent conductive film are electrically brought into contact with each other by an input operation.
